(19) United States
(12) Patent Application Publication
(10) Pub. No.: US 2005/0123250 A1
(43) Pub. Date: Jun. 9, 2005

(54) Arrangement for connecting an optical waveguide to a microprocessor-controlled electrical appliance

(75) Inventor: Neumann Gotz, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/001,561

(22) Filed: Dec. 2, 2004

(30) Foreign Application Priority Data
Dec. 3, 2003 (DE) 103 57416.6

(51) Int. Cl. G02B 6/36

(52) U.S. Cl. 385/88

(57) ABSTRACT

The invention relates to an arrangement for connecting an optical waveguide to a microprocessor-controlled electrical appliance having an arithmetic module which is connected to the electrical appliance and has network functionalities for linking the electrical appliance to a network, an interface chip, connected to the arithmetic module, in the form of an integrated circuit chip, and an optical transmission and reception chip which is connected firstly to the interface chip and secondly to the optical waveguide. In order to make such an arrangement particularly efficient, provision is made for the interface chip to have integrated functional modules which provide at least some of the network functionalities.

### CLAIM FOR PRIORITY

This application claims the benefit of priority to German Application No. 103 57 416.6 as filed in the German language on Dec. 3, 2003, the contents of which are hereby incorporated by reference.

### TECHNICAL FIELD OF THE INVENTION

The invention relate to an arrangement for connection an optical waveguide to a microprocessor-controlled electrical appliance.

### BACKGROUND OF THE INVENTION

Electrical systems today are frequently of decentralized design, i.e. they have electrical appliances which are distributed in their arrangement and are normally microprocessor-controlled. Thus, by way of example, single appliances for telecommunication, such as telecommunication terminals and exchange equipment, together form a telecommunication network and single computers, such as PCs or servers, are connected to one another to form computer networks. Similarly, “field transmitters”, such as those used in industrial production processes, power or process engineering systems or else installations for distributing electricity, gas or water, are normally arranged in decentralized fashion and are combined to form a network for the purpose of data interchange with one another and/or with a control center. Such networks may be designed, by way of example, on the basis of the generally known Ethernet standard.

In communication networks, data to be transmitted between the individual electrical appliances are transmitted using “interconnect media”. Such interconnect media used may be, by way of example, electrical transmission lines (such as twisted-pair lines) or optical waveguides. In the case of an optical waveguide, the data are transmitted in the form of pulses of light using optical fibers. To couple them to the respective appliances in the network, the optical waveguides are connected by means of appropriate interfaces to optical transmission and reception chips containing these interfaces.

The invention relates to an arrangement for connecting an optical waveguide to a microprocessor-controlled electrical appliance having an arithmetic module which is connected to the electrical appliance and has network functionalities for linking the electrical appliance to a network, an interface chip, connected to the arithmetic module, in the form of an integrated circuit chip, and an optical transmission and reception chip which is connected firstly to the interface chip and secondly to the optical waveguide.

An arrangement of this type is known, by way of example, from the German translation DE 696 15 249 T2 of the European patent specification EP 0 735 706 B1. In the case of the known arrangement, an interface device is described for the purpose of connecting an optical waveguide to an electrical appliance, said interface device having a first IC (Integrated Circuit) connected to the electrical appliance as an arithmetic module, which is in turn connected to a second IC. The latter provides an interface chip for an optical connector which has an optical transmitter and receiver and is in turn connected to the optical waveguide. The entire interface device may be used to convert input data generated in an electrical appliance into corresponding pulses of light and to send them to or receive them from a remote electrical appliance via the optical waveguide and to convert them into corresponding output data for the electrical appliance. These output data are made available to the electrical appliance, which can process them further, store them or output them, for example.

In this context, the first IC, which is connected directly to the electrical appliance in the case of the known interface device, has the network functionalities required for linking the electrical appliance to the network, that is to say functionalities for controlling, checking and processing the flow of data, such as a logic link control layer (LLC), a media access layer (MAC=Media Access Controller) and a “signal sublayer”. These layers represent individual components of the OSI layer model (OSI Open Systems Interconnection), which describes a general basis for designing and implementing hardware and software for network applications. In this context, the individual layers control the flow of data, for example, or make error recognition and correction functionalities available.

The second IC, which is connected to the first IC, serves as a bidirectional interface between this first IC and the optical connector and converts the data which are to be transmitted by the electrical appliance into pulses which the optical connector can understand. Similarly, this second IC converts data received from the optical connector into data which the electrical appliance can understand.

The optical connector contains an optical transmitter, such as a light-emitting diode, for transmitting optical pulses at a prescribed wavelength, and an optical receiver, such as a photoreceiver. Suitable connections are used to connect an optical waveguide pair to the optical connector.

### SUMMARY OF THE INVENTION

The invention generally discloses a particularly efficient arrangement for connecting an optical waveguide to an electrical appliance.

In one embodiment of the invention, there is an arrangement in which the interface chip has integrated functional modules which provide at least some of the network functionalities.

In one aspect of the invention, functional modules are not necessarily separate electronic components, but rather functional modules of this type are integrated completely in the interface chip; their functionality is provided by means of appropriate logic circuits.

One advantage of the invention is that, besides its function as a bi-directional interface between the arithmetic module and the transmission and reception chip, the interface chip also provides network functionalities, which have normally had to be performed by the arithmetic module to date. In other words, at least some of the tasks of the arithmetic module have been moved to the interface chip. Since the interface chip is an integrated circuit chip, such integration of further functions is possible—depending on the complexity of the integrated circuit chip—without great involvement. This measure significantly relieves the load on a microprocessor which is normally present in the arithmetic module. Under some circumstances, it is even possible to resort to a less powerful microprocessor in this case, which lowers the costs for the overall arrangement. In addition, the lower utilization level of dissipated by emanating from the microprocessor, which is a significant advantage for small electrical appliances in closed housings.

One advantageous embodiment of the invention is that at least one functional module integrated in the interface chip provides a switch functionality.

A chip with switch functionality in a network sets up connections between individual electrical appliances in the network, the switch allowing a plurality of electrical appliances to communicate with one another at the same time. This means that, by way of example, it is particularly advantageously possible to implement redundancy changeover, that is to say changeover from one electrical appliance to a second electrical appliance (of the same type) as smoothly as possible.

A further advantageous embodiment is that at least one functional module integrated in the interface chip provides a filter functionality. This means that, by way of example, received data can be filtered actually in the interface unit and not in the arithmetic module. Since filtering processes are normally arithmetic-intensive operations, moving the filtering to the interface chip again relieves the load on the arithmetic module's microprocessor.

In line with further advantageous embodiments, the interface chip may be formed, by way of example, by a programmable circuit chip, such as an EPLD (Electronically Programmable Logic Device) or an FPGA (Field Programmable Gate Array), and also by a nonprogrammable circuit chip, such as an ASIC (Application-Specific Integrated Circuit).

An ASIC may advantageously be used particularly in areas where large quantities of the same circuit chip are intended to be manufactured at low manufacturing cost. By contrast, the use of programmable circuit chips, such as an FPGA or an EPLD, is suitable particularly for appliances which are produced in low to medium quantities.

An advantage to each of these embodiments is, in particular, that the interface chip can be matched to the respectively demanded application on a variable basis. Besides the opportunity to provide almost any network functionalities in a circuit chip of corresponding complexity, producing an optical interface which permits low-power transmission light-emitting diodes to be connected also allows significant minimization of the power loss from the overall arrangement, for example.

### BRIEF DESCRIPTION OF THE DRAWINGS

The invention is explained in more detail below with reference to the drawings and exemplary embodiments, in which:

FIGURE 1 shows a schematic view of an exemplary embodiment of an arrangement for linking an optical waveguide to a microprocessor-controlled electrical appliance.

### DETAILED DESCRIPTION OF THE INVENTION

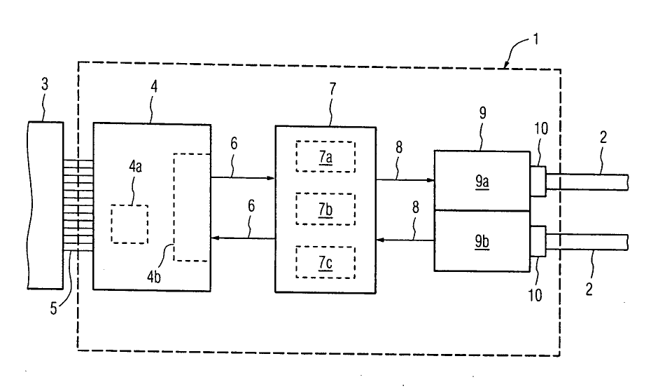

FIGURE 1 shows (in a frame drawn in dashed lines) an arrangement 1 for linking an optical waveguide pair 2 to a microprocessor-controlled electrical appliance 3 (only the start of which is shown in the FIGURE). The microprocessor-controlled electrical appliance 3 may be, by way of example, a computer, an appliance for telecommunication or a field transmitter, for example in a control system, for controlling the distribution of electricity.

The arrangement 1 has an arithmetic chip 4 which is connected to the electrical appliance 3 by means of appropriate electrical connections 5—indicated merely schematically in the FIGURE. The arithmetic chip 4 is used to control the data interchange between the electrical appliance 3 and a remotely arranged further electrical appliance via the optical waveguides 2. To this end, the arithmetic chip 4 includes, inter alia, a microprocessor 4a and a “media access controller” (MAC) 4b. The arithmetic chip is also connected via connections 6 to an interface chip 7, which in turn is connected to a transmission and reception chip 9 via further connections 8. The transmission and reception chip includes an optical transmitter 9a, for example in the form of a light-emitting diode, and an optical receiver 9b, for example in the form of a photoreceiver. The transmission and reception chip 9 is connected to the optical waveguides 2 via appropriate optical couplers 10. Normally, a respective optical waveguide is available both for the reception direction and for the transmission direction.

The interface chip 7 is in the form of an integrated circuit chip, such as a programmable circuit chip—for example an FPGA or an EPLD—, or of a nonprogrammable circuit chip—for example an ASIC. Such integrated circuit chips have the particular advantage that their design can be tailored exactly to their later function of use. It is thus possible to develop an exactly suitable integrated circuit chip for every function of use. For this purpose, there are special design tools, but these will not be discussed in more detail at this juncture.

The interface chip 7 serves, in line with its original function, first of all as a converter of data which are to be transmitted from the electrical appliance to the optical transmission and reception chip via the arithmetic chip, or to be received in the opposite direction. To this end, the interface chip 7 converts the data which are output by the arithmetic module 4 on the basis of a standard for optical interfaces (for example PECL=Pseudo Emitter Coupled Logic) and outputs them to the optical transmission and reception chip 9, where they are converted into corresponding pulses of light and are transmitted via the optical waveguides 2. Besides its interface functionality, the interface chip 7 has functional modules 7a, 7b and 7c—indicated merely schematically in the FIGURE—which provide network functionalities. By way of example, the functional module 7a may provide a switch functionality in this case and may thus control the connection of two electrical appliances via a network. The switch functionality may likewise be used to perform rapid redundancy changeover in the event of failure of the electrical appliance 3, in which case there is changeover to an electrical appliance of the same type. By way of example, the functional module 7b represents an electronic filter, e.g. for filtering received data. Since the interface chip 7 is an integrated circuit chip, such functions may be integrated into it in the form of an appropriate logic circuit designed for the interface chip 7. The performance of the corresponding functions by the interface chip 7 relieves the load on the microprocessor 4a in the arithmetic chip 4 to a significant extent and increases the efficiency of the entire arrangement overall. If appropriate, it is also possible to resort to a less powerful microprocessor 4a, which would make the overall arrangement less expensive. In addition, relieving the load on the microprocessor 4a means that it is possible to reduce the amount of heat dissipated by the arithmetic chip 4a, which affords the advantage of a lower cooling requirement for the arrangement particularly in the case of a space-saving design for the overall arrangement 1 or when the arrangement is in a small housing. In addition, the fact that the interface chip 7 in the form of an FPGA, of an EPLD or of an ASIC can be tailored to its application on a variable basis means that it is also possible to provide an optical interface having low power loss, for example a TTL interface (TTL=Transistor-Transistor Logic), in this case. This allows less powerful light-emitting diodes to be actuated in the transmission and reception chip 9 and allows the power consumption and hence the heat dissipation of the overall arrangement 1 to be significantly reduced.

In comparison with hitherto frequently used “PHY transceivers” as interface chips, which frequently provide both an optical and an electrical interface, consciously omitting the electrical interface also allows the power loss and hence the evolution of heat from the overall arrangement 1 to be kept comparatively low.

The overall arrangement 1 may be held, by way of example, in an external housing and may be connected to the electrical appliance 3 by means of an appropriate interface connection. Normally, however, the arrangement 1 will be implemented on a push-in printed circuit board, for example, and will be inserted into the electrical appliance 3. In such a case, the reduced evolution of heat from the arrangement 1 is also of benefit to the overall electrical appliance.

1. An arrangement for connecting an optical waveguide to a microprocessor-controlled electrical appliance, comprising:
an arithmetic module which is connected to the electrical appliance and has network functionalities for linking the electrical appliance to a network;
an interface chip, connected to the arithmetic module, formed as an integrated circuit chip; and
an optical transmission and reception chip which is connected firstly to the interface chip and secondly to the optical waveguide; wherein
the interface chip has integrated functional modules which provide at least some of the network functionalities.

2. The arrangement as claimed in claim 1, wherein at least one functional module integrated in the interface chip provides a switch functionality.

3. The arrangement as claimed in claim 1, wherein
at least one functional module integrated in the interface chip provides a filter functionality.

4. The arrangement as claimed in claim 1, wherein the interface chip is an EPLD.

5. The arrangement as claimed in claim 1, wherein the interface chip is an FPGA.

6. The arrangement as claimed in claim 1, wherein the interface chip is an ASIC.
